(19) United States
(12) Patent Application Publication
(10) Pub. No.: US 2025/0307608 A1
(43) Pub. Date: Oct. 2, 2025

(54) Systems And Methods For Providing Content Recommendations

(71) Applicant: Comcast Cable Communications, LLC, Philadelphia, PA (US)

(72) Inventors: Javier Morales Delgado, Fall Church, VA (US); Shaghayegh Agah, San Mateo, CA (US); Maria Peifer, Philadelphia, PA (US)

(21) Appl. No.: 18/620,668

(22) Filed: Mar. 28, 2024

(51) Int. Cl. G06N 3/0455

(52) U.S. Cl. CPC G06N 3/0455

(57) ABSTRACT

Systems, apparatuses, and methods are described for providing content recommendations using recursive learning transformers. A computing platform may train machine learning models (e.g., transformers) to generate content recommendations based on data structures summarizing user content preference information. The machine learning models may utilize a long-term memory data structure comprising a summary of user content preference information over any period of time (e.g., the entire length of time a user is associated with the computing platform) to generate the content recommendations. The long-term memory data structure may be recursively updated to maintain the summary without increasing storage requirements.

### BACKGROUND

Content providers may provide content recommendations to computing devices such as smart TVs, smart displays, modems, set top boxes, gateways, wireless routers, or other electronic devices. Content recommendations may be determined based on user content preferences. However, device limitations may restrict the amount of user content preference information that can be maintained. Restrictions to the amount of user content preference information that can be maintained may limit the efficacy and/or accuracy of the content recommendations.

### SUMMARY

The following summary presents a simplified summary of certain features. The summary is not an extensive overview and is not intended to identify key or critical elements.

Systems, apparatuses, and methods are described for providing content recommendations using recursive learning. A computing platform, for example, a recursive embedding learning platform, may train one or more machine learning models (e.g., transformers). A first machine learning model may generate data structures (e.g., content recommendation data structures), such as vectors, embeddings, or the like, summarizing user content preference information (e.g., “memory”) received by the computing platform, using a recursively updated data structure (e.g., a long-term memory data structure) summarizing user content preferences over any period of time. A second machine learning model may generate content recommendations based on data structures generated by the first machine learning model. Based on outputting the content recommendations, the computing platform may update the recursively updated data structure such that the data structure maintains an up-to-date record of user content preference information without increasing storage requirements or otherwise limiting the amount of information that the data structure maintains.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network for providing content recommendations.

FIG. 2 shows hardware elements of a computing device.

FIG. 3 shows a block diagram showing an example of a computing platform for providing content recommendations.

FIGS. 4A-4C show communications and/or steps in one or more example methods associated with providing content recommendations.

FIG. 5 shows an example user interface for content recommendations.

FIGS. 6A-6B show a flow chart showing an example method for providing content recommendations.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

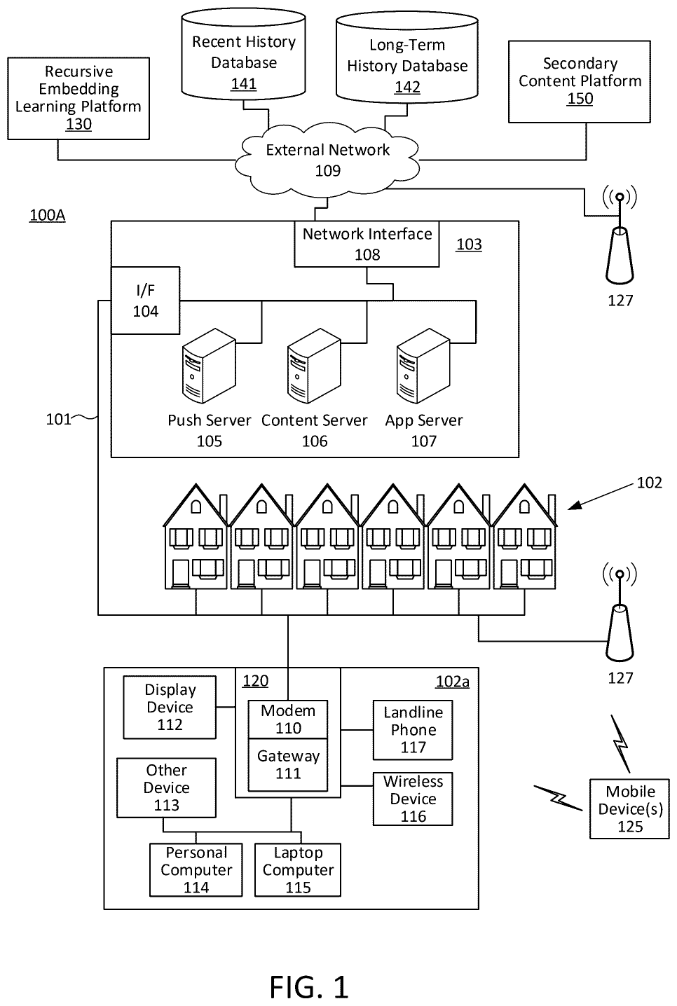

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a Wi-Fi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. For example, the external networks 109 may comprise networks of devices including databases (such as recent history database 141 and long-term history database 142, and/or other databases) and/or systems of devices (e.g., computing platforms, such as recursive embedding learning platform 130, secondary content platform 150, and/or other systems). Recent history database 141, long-term history database 142, recursive embedding learning platform 130, and secondary content platform 150 are further described below. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, games, text, web pages, images, files, etc. The content server 106 (and/or an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements and/or providing content recommendations. Yet another application server may be responsible for formatting and inserting advertisements in a video stream being transmitted to devices in the premises 102 and/or to the mobile devices 125. Additionally or alternatively, an application server may be responsible for providing content recommendations to one or more gateways, such as a gateway 111, at one or more premises such as premises 102a. The local office 103 may comprise additional servers, such as additional push, content, and/or application servers, and/or other types of servers. Although shown separately, the push notification server 105, the content server 106, the application server 107, and/or other server(s) may be combined. The servers 105, 106, 107, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

A recursive embedding learning platform (RELP) 130 may comprise one or more computing devices, such as servers, laptop computers, desktop computers, mobile devices, tablets, and/or other computing devices. The RELP 130 may be maintained by, hosted by, and/or otherwise associated with an entity (e.g., a commercial entity providing content and/or services to users). The RELP 130 may be used to configure, train, and/or execute one or more machine learning models, such as a long-term memory (LTM) transformer, a content recommendation (CR) transformer, and/or other machine learning models. For example, the RELP 130 may train the one or more machine learning models to generate data structures (e.g., vectors, embeddings, or the like), such as CR data structures, that summarize user content preference information over periods of time for use in providing content recommendations. The periods of time may correspond to terms associated with providing content recommendations (e.g., a predetermined number of days, weeks, months, or the like during which user content preference information is summarized). Additionally, the RELP 130 may train the one or more machine learning models to generate content recommendations based on the data structures. One or more databases, such as recent history database 141, long-term history database 142, and/or other databases, may communicate (e.g., via a wired or wireless external network 109) with the RELP 130 to continuously or periodically (e.g., at regular or irregular intervals) provide content viewing information used to generate the data structures and/or content recommendations. The RELP 130 may communicate with a computing device of external network 109, for example a secondary content platform 150, to provide content recommendations, provide records of user content preferences, provide impression reports, receive content recommendation incentives, and/or perform other functions.

A recursive embedding learning platform may be associated with a service (e.g., a streaming service) that provides content recommendations tailored to a user's preferences. The content recommendations may be based on content viewing information (e.g., indications content was viewed, a length of time during which content was viewed, a time at which content was viewed, an indication of the device communicating the content viewing information, attributes of content that was viewed, and/or other content viewing information). However, various factors (e.g., device limitations, commercial considerations, and/or other factors) may limit the amount of content viewing information that may be stored. Systems providing similar services and/or content recommendations may limit storage of content viewing information to a particular period of time to address such factors. However, limiting the amount of content viewing information stored to the particular period of time provides an incomplete view of the users' evolved preferences over extended periods of time.

To provide a more complete view of the users' preferences, and as described herein, a recursive embedding learning platform such as RELP 130 may utilize one or more machine learning models to generate data structures (e.g., embeddings, vectors, profiles, electronic files, and/or other data structures) comprising a summary of the users' preferences that represents user preferences over any period of time without increasing the resources required for storage of the user preferences. To generate such data structures, the recursive embedding learning platform may use the one or more machine learning models to convert content viewing information to summaries of user preferences and recursively update the data structures. The recursive embedding learning platform may simultaneously compress the size of the data structures to maintain the same storage requirements each time new content viewing information is added. The recursive embedding learning platform may use these data structures to generate content recommendations for a user based on the entire history of content viewing information associated with the user. The recursive embedding learning platform may repeat the functions described above as part of an iterative feedback loop for providing content recommendations using recursive learning, as described herein.

The recent history database (RHDB) 141 shown in FIG. 1 may comprise a centralized database, a cloud database, a distributed database, and/or other type of computing device(s) that may be configured to store information related to user preferences and/or content recommendation. A computing device in the premises 102a that is separate from the RHDB 141, for example, the laptop computer 115, wireless device 116, personal computer 114, display device 112, etc., may communicate (e.g., via a wired or wireless network of the premises 102a and through the gateway 111) with the RHDB 141 to continuously or periodically provide content viewing information designated as recent content viewing information to the RHDB 141. The RHDB 141 may communicate with a computing device or platform, such as RELP 130 and/or other computing devices/platforms, to provide recent content viewing information (e.g., for generating content recommendations, and/or other functions). Content viewing information designated as “recent” content viewing information may comprise content viewing information for content that was viewed within a predetermined term for providing content recommendations (e.g., a number of hours, a number of days, a number of months, a number of years, and/or other periods of time). The term may be based on hardware limitations and/or preferences of an entity maintaining and/or hosting the RHDB 141 (e.g., the entity associated with the RELP 130, and/or other entities).

The term may determine a limit for storing recent content viewing information by the RHDB 141. For example, the term may be six months, causing content viewing information received by the RHDB 141 to be designated as long-term content viewing information once six months have passed. T RHDB 141 may subsequently remove the long-term content viewing information from the RHDB 141. The RHDB 141 may remove the long-term content viewing information by transferring the long-term content viewing information to one or more additional databases (e.g., long-term history database 142, and/or other databases).

The long-term history database (LTHDB) 142 shown in FIG. 1 may comprise a centralized database, a cloud database, a distributed database, and/or other type of computing device(s) that may be configured to store information related to user preferences and/or content recommendation. The LTHDB 142 may communicate with one or more databases, such as RHDB 141, to receive content viewing information designated as long-term content viewing information. The LTHDB 142 may communicate with a computing device or platform, such as RELP 130 and/or other computing devices/platforms, to provide long-term content viewing information (e.g., for generating content recommendations, and/or other functions). Content viewing information designated as the “long-term” content viewing information may comprise content viewing information that was viewed within a second predetermined term matching the predetermined term associated with the RHDB 141. For example, the term associated with the RHDB 141 may be six months spanning from January through June of a calendar year and the second term, associated with the LTHDB 142, may be the previous six months spanning from July through December of the previous calendar year. The second term may be based on hardware limitations and/or preferences of an entity maintaining and/or hosting the LTHDB 142 (e.g., the entity associated with the RELP 130 and/or RHDB 141, and/or other entities).

The second term may determine the length of time long-term content viewing information is stored by the LTHDB 142. For example, the second term may be six months, causing content viewing information received by the LTHDB 142 to be designated as expired once six months have passed. The LTHDB 142 may subsequently remove the expired content viewing information from the LTHDB 142.

Although only one RHDB 141 and one LTHDB 142 are depicted herein, any number of such devices may be used to implement the methods described herein without departing from the scope of the disclosure. Additionally, although the RHDB 141 and the LTHDB 142 are depicted as separate devices, in some examples RHDB 141 and LTHDB 142 may be components of a single larger database, and/or one or both of the RHDB 141 and the LTHDB 142 may be components of the RELP 130 (e.g., as components of memory 132) without departing from the scope of this disclosure.

The secondary content platform (SCP) 150 shown in FIG. 1 may comprise one or more computing devices, such as servers, laptop computers, desktop computers, and/or other computing devices. The SCP 150 may be maintained by, hosted by, and/or otherwise associated with an entity (e.g., a commercial entity providing content and/or services to users) different from the entity associated with RELP 130. For example, the SCP 150 may provide content and/or streaming services to users at a premises such as premises 102a. A computing device such as the RELP 130 may communicate with the SCP 150 to provide content recommendations, records of user content preferences, and/or impression reports indicating whether content provided by the SCP 150 and recommended by the RELP 130 was viewed by a user. The SCP 150 may provide its content and/or services based on content recommendations received from the RELP 130. Based on receiving content recommendations and/or impression reports from a device such as the RELP 130, the SCP 150 may provide content recommendation incentives (e.g., revenue shares, credits, and/or other incentives) to the device in exchange for the content recommendations and/or impression reports.

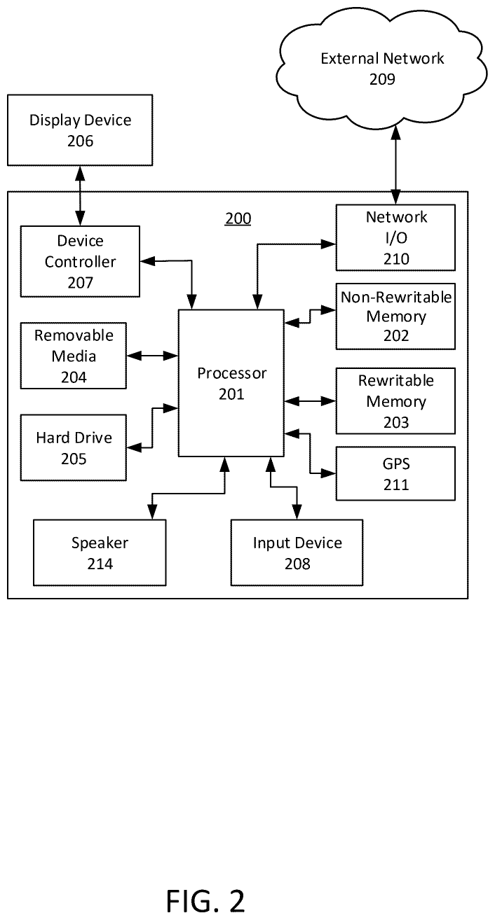

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., recent history database 141, long-term history database 142, recursive embedding learning platform 130, secondary content platform 150, and/or other computing devices). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

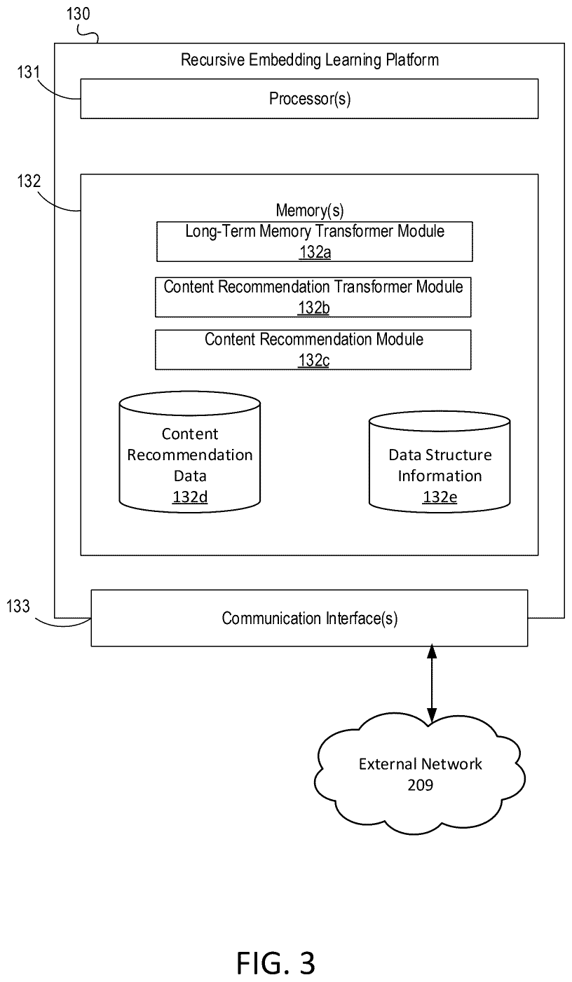

FIG. 3 shows a block diagram providing an example of a RELP 130, which may be used to implement features described herein. The RELP 130 may comprise one or more processors 131, which may execute instructions of a computer program to perform any of the functions associated with the RELP 130 described herein. The instructions may be stored in memory 132, which may comprise non-rewritable memory such as ROM, rewritable memory such as RAM and/or flash memory, removable media (e.g., a USB drive, a compact disk (CD), a digital versatile disk (DVD)), and/or any other type of computer-readable medium or memory. The instructions may comprise one or more modules for performing the functions associated with the RELP 130 described herein. For example, the memory 132 may comprise a long-term memory transformer module 132a, a content recommendation transformer module 132b, a content recommendation module 132c, and/or other modules. Long-term memory transformer module 132a may comprise instructions that direct and/or cause RELP 130 to train an LTM transformer, generate CR data structures, update LTM data structures, and/or perform other functions. Content recommendation transformer module 132b may comprise instructions that direct and/or cause RELP 130 to train a CR transformer, generate content recommendations based on input of CR data structures, and/or perform other functions. Content recommendation module 132c may comprise instructions that cause RELP 130 to provide content recommendations to one or more computing devices (e.g., an SCP 150, a gateway 111, and/or other computing devices), provide impression reports, receive content recommendation incentives, update content recommendations, and/or perform other functions.

The memory 132 may comprise one or more sets of information for implementing the features described herein. For example, the memory 312 may comprise a set of content recommendation data 132d, such as indications of content recommended by the RELP 130, recommended content viewing information, and/or other data related to content recommendations. Additionally or alternatively, the RELP 130 may comprise a set of data structure information 132e, such as LTM data structures, CR data structures, recent content viewing information, long-term content viewing information, and/or other data related to generating data structures as described herein. The communication interface 133 may comprise a network interface, such as a network input/output (I/O) interface (e.g., a network card) to communicate with an external network 209. The communication interface 133 may be a wired interface (e.g., electrical, RF (via coax), optical (via fiber)), a wireless interface, or a combination of the two. The communication interface 133 may comprise a modem configured to communicate via the external network 209.

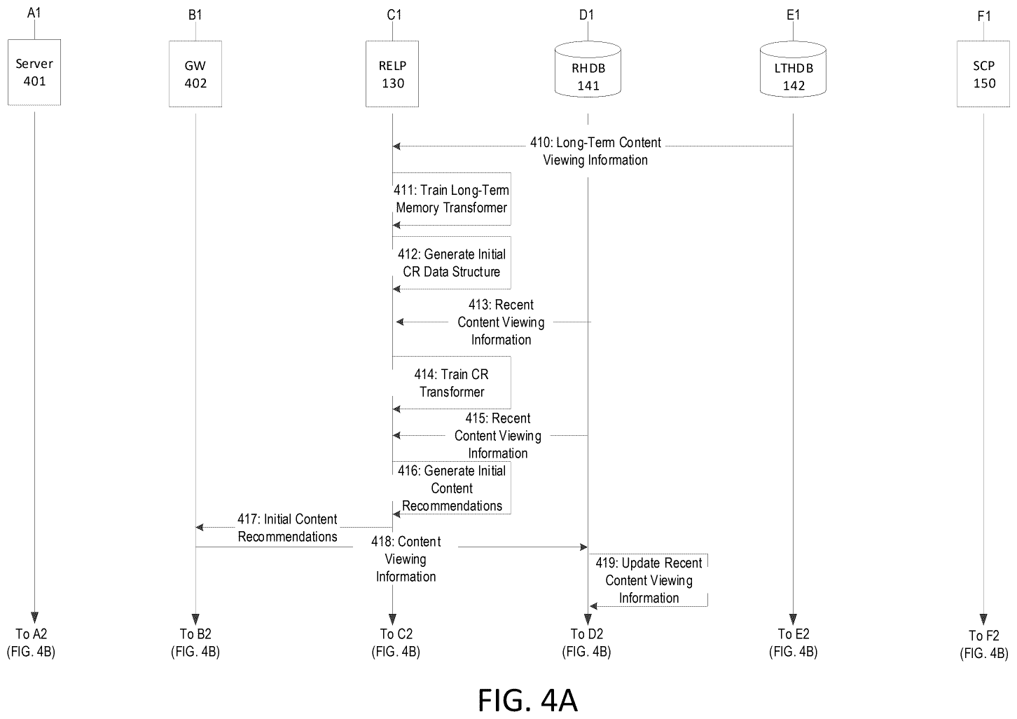

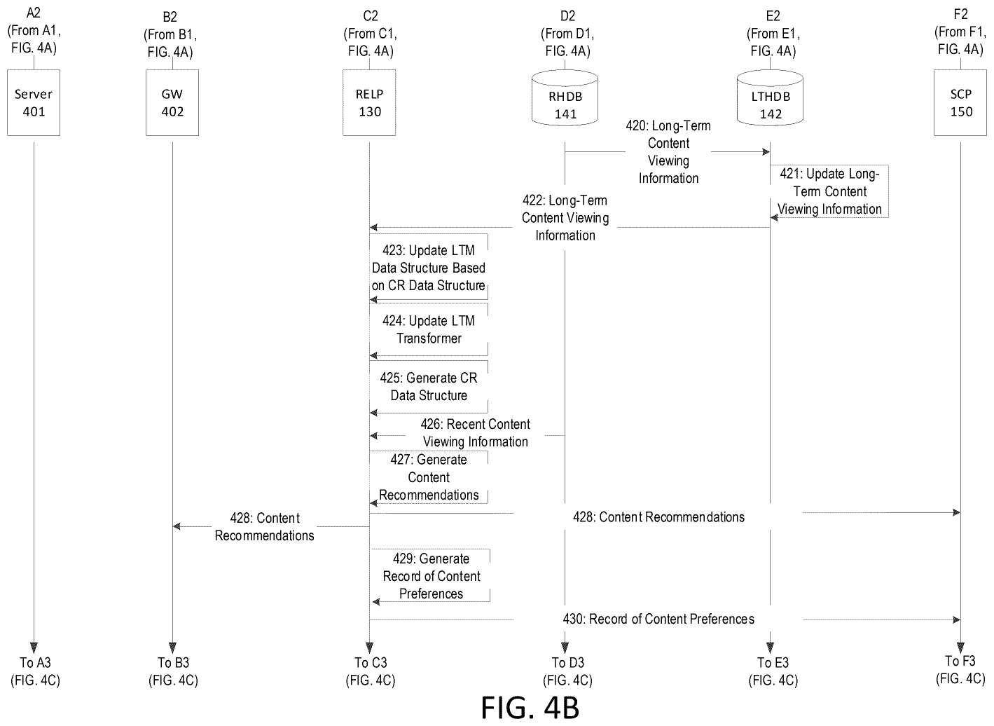

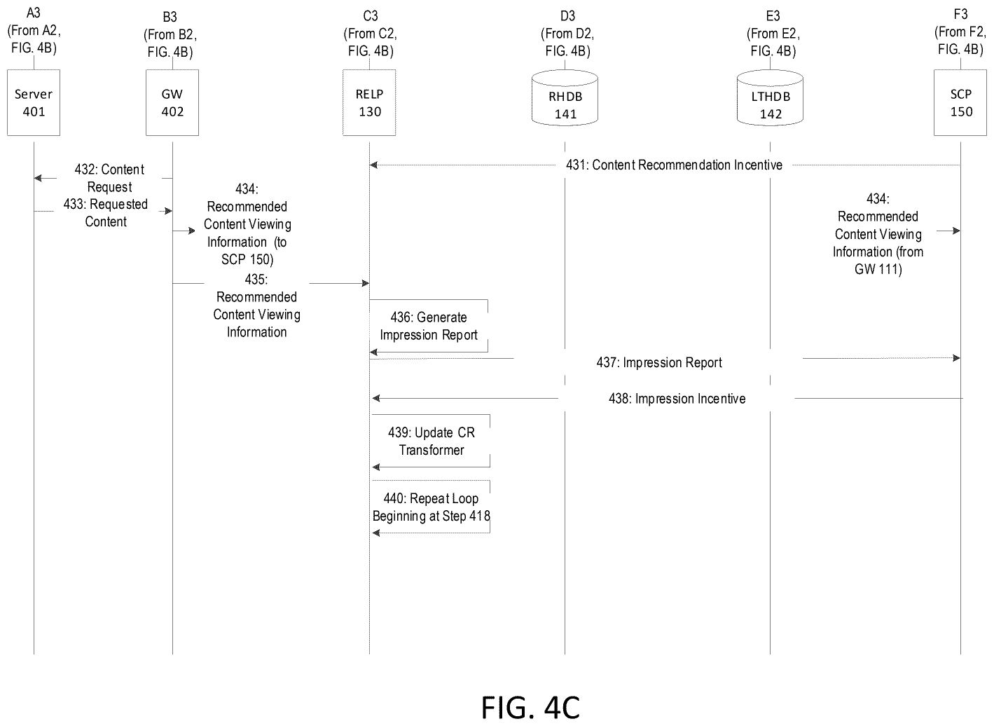

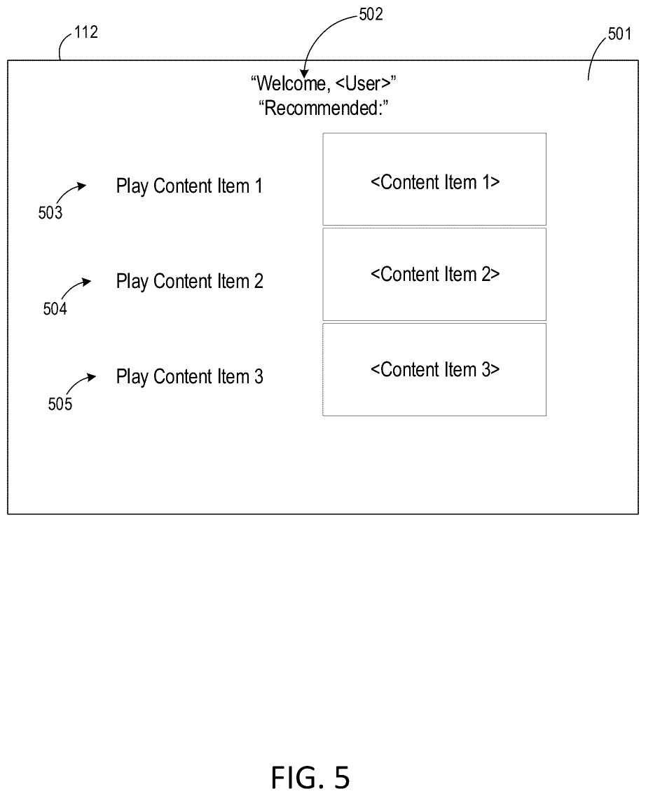

FIGS. 4A-4C are a diagram showing communications and/or steps in one or more example methods associated with providing content recommendations using recursive learning, as described herein. FIG. 4B is a continuation of FIG. 4A, as indicated at the bottom of FIG. 4A and at the top of FIG. 4B. FIG. 4C is a continuation of FIG. 4B, as indicated at the bottom of FIG. 4B and at the top of FIG. 4C. FIG. 5 is a diagram showing an example of features that may be comprised by one or more of the communications and/or steps shown in FIGS. 4A-4C.

A server 401 may comprise one or more servers (e.g., 105, 106, 107, etc.) and/or other computing devices that provide content and/or content recommendations to users. A gateway, for example, the GW 402, may communicate with the server 401 to receive content and/or content recommendations and route them to an appropriate computing device at a premises (e.g., premises 102a), such as a display device 112, a laptop computer 115, a mobile device 125, a personal computer 114, a wireless device 116, and/or other devices 113. The server 401 may be operated by (and/or on behalf of, with the authorization of, and/or otherwise in association with) one or more content providers. Vertical lines A1 (FIG. 4A), A2 (FIG. 4B), and A3 (FIG. 4C) correspond to the server 401. The GW 402 may comprise a gateway, such as the gateway 111, and/or other computing devices that provide content and/or content recommendations to the appropriate computing device at the premises 102a. The GW 402 may additionally provide recommended content viewing information (e.g., indications content was viewed, a length of time during which content was viewed, a time at which content was viewed, an indication of the device communicating the content viewing information, attributes of content that was viewed, and/or other content viewing information) corresponding to content recommended by, for example, a RELP 130. For example, the GW 402 may communicate with the RELP 130 via one or more communication interfaces to send and/or broadcast the recommended content viewing information to the RELP 130. Vertical lines B1 (FIG. 4A), B2 (FIG. 4B), and B3 (FIG. 4C) correspond to the GW 402.

Also shown in FIGS. 4A-4C are the RELP 130, the RHDB 141, the LTHDB 142, and the SCP 150. Vertical lines C1 (FIG. 4A), C2 (FIG. 4B), and C3 (FIG. 4C) correspond to the RELP 130. Vertical lines D1 (FIG. 4A), D2 (FIG. 4B), and D3 (FIG. 4C) correspond to the RHDB 141. Vertical lines E1 (FIG. 4A), E2 (FIG. 4B), and E3 (FIG. 4C) correspond to the LTHDB 142. Vertical lines F1 (FIG. 4A), F2 (FIG. 4B), and F3 (FIG. 4C) correspond to the SCP 150.

One or more of the computing devices shown in FIGS. 4A-4C may be combined or omitted, and/or additional computing devices may be added. The communications and steps shown in FIGS. 4A-4C need not be performed in the order shown and/or may be sent by, received from, or performed by different computing devices. One or more of those communications and/or steps may be combined, omitted, or modified, and/or other steps and/or communications may be added. A request, response, and/or other communication shown in, and/or described in connection with, FIGS. 4A-4C need not be a single message nor contained in a single packet, block, or other transmission unit.

At step 410, and as part of generating initial content recommendations (e.g., as part of a first/training iteration of a feedback loop), the RELP 130 may receive long-term content viewing information from the LTHDB 142. For example, the RELP 130 may receive the long-term content viewing information via the communication interface 133. The long-term content viewing information may be received as a stream of data, a data file, and/or any other means of providing data from one computing device to another computing device.

The long-term content viewing information may comprise content viewing information (e.g., indications content was viewed, a length of time during which content was viewed, a time at which content was viewed, an indication of the device communicating the content viewing information, attributes of content that was viewed, and/or other information associated with one or more content items) that corresponds to a particular term (e.g., a number of days, a number of weeks, a number of months, a number of years, and/or any other periods of time). For example, a system performing the functions described herein may maintain a temporary repository, such as the LTHDB 142, of content viewing information for one or more users. The temporary repository may store content viewing information for a first term (e.g., six months, such as July through December of a calendar year, and/or other periods of time). Any content viewing information stored (e.g., by the LTHDB 142, or the like) for the first term may be designated as long-term content viewing information and may be deleted once the first term expires.

The system performing the functions described herein may also maintain an additional temporary repository, such as the RHDB 141, which may store content viewing information designated as recent content viewing information for a second term (which may, e.g., correspond to the first term). The second term may follow the first term, for example, the second term may comprise the six months of January through June of a subsequent calendar year. The temporary repositories, for example, LTHDB 142 and RHDB 141, may be combined and/or may share a single computing device (e.g., a single database, and/or other computing devices). As described further below, the recent content viewing information may be designated as long-term content viewing information once the second term expires and may be removed from one repository, such as RHDB 141, and sent to another repository, such as LTHDB 142. The periods of time described herein may be determined by a ruleset provided by an entity (e.g., the entity associated with RELP 130, and/or other entities) and may be manually or automatically updated at any time.

At step 411, the RELP 130 may (e.g., based on receiving the long-term content viewing information) train a long-term memory (LTM) transformer, and/or other machine learning models. Training the LTM transformer may configure the LTM transformer to output content recommendation (CR) data structures based on input of LTM data structures and content viewing information. The CR and LTM data structures may comprise vectors, profiles, electronic files, and/or other data structures that summarize user content preferences over periods of time. The RELP 130 may train the LTM transformer based on the long-term content viewing information of step 410. For example, the RELP 130 may process the long-term content viewing information using one or more processors by applying natural language processing and/or understanding, supervised machine learning methods (e.g., regression, classification, neural networks, support vector machines, random forest models, naïve Bayesian models, and/or other supervised methods), unsupervised machine learning methods (e.g., principal component analysis, hierarchical clustering, K-means clustering, and/or other unsupervised methods), and/or other methods.

In training the LTM transformer, the RELP 130 may identify one or more attributes in the long-term content viewing information that correspond to user content preferences. The one or more attributes may comprise attributes of particular content items identified by the long-term content viewing information, such as a title of the content item, individuals (e.g., actors, directors, or the like) associated with the content item, a genre (e.g., action, drama, science fiction, mystery, comedy, sports, and/or other genres) of the content item, a type of content associated with the content item (e.g., a movie, episodic content (e.g., a series of episodes), advertising content, video game content, audio content (e.g., music, podcasts, and/or other audio content), and/or other types of content), a particular time (e.g., time of day, time of month, time of year, a holiday, and/or other times) associated with viewing the content item, and/or any other attributes of content items. For example, the RELP 130 may process long-term content viewing information indicating that one or more users (who may, e.g., share one or more demographic traits, such as a geographic location, a service level, an age, a gender, and/or other demographic traits) viewed the same content item, for example, an action movie, on the same day (e.g., December 25^{th}). Accordingly, the RELP 130 may identify attributes of the content item such as the title of the content item, individuals (e.g., actors, directors, or the like) associated with the content item, a genre, such as action movie, of the content item, a type of content, such as movie, associated with the content item, a time of year, such as December 25^{th}, associated with viewing the content item, and/or any other attributes.

Based on identifying the one or more attributes, the RELP 130 may cause the LTM transformer to store one or more correlations between the attributes and user content preferences. For example, based on identifying that one or more users viewed the same action movie on December 25^{th}, the RELP 130 may cause the LTM transformer to store one or more correlations indicating user content preferences for viewing action movies on December 25^{th}, viewing any content items associated with a particular actor of the action movie on December 25^{th}, viewing action movies generally on December 25^{th}, and/or any other user content preferences. The one or more correlations may be used by the LTM transformer to generate CR data structures summarizing the user content preferences (e.g., for use in providing content recommendations), as described further below. The methods by which the RELP 130 may train the LTM transformer may comprise additional and/or alternative parameters and/or training information without departing from the scope of this disclosure.

At step 412, the RELP 130 may (e.g., based on training the LTM transformer) generate an initial CR data structure. The RELP 130 may generate the initial CR data structure by inputting long-term content viewing information into the LTM transformer. For example, the RELP 130 may generate an initial CR data structure, based on the long-term content viewing information of step 410, summarizing a user's content preferences over a period of time corresponding to the term of the long-term content viewing information (e.g., a period of days, weeks, months, years, for example, six months, and/or other periods of time). In generating the initial CR data structure, the RELP 130 may cause the LTM transformer to utilize one or more stored correlations indicating user content preferences. The LTM transformer may use the one or more stored correlations to convert long-term content viewing information into a summary of a user's content preferences. For example, the LTM transformer may identify one or more stored correlations indicating that a particular user (or group of users) viewed a number (e.g., six) of comedy series of episodes and a number (e.g., two) of drama movies over six months. Based on the one or more stored correlations, the LTM transformer may generate an initial CR data structure comprising user content preference information indicating a preference for comedy content items over drama content items, user content preference information indicating a preference for a series of episodes over movies, and/or other user content preference information.

Additionally or alternatively, in generating the initial CR data structure, the RELP 130 may cause the LTM transformer to generate one or more preference scores based on the long-term content viewing information. The RELP 130 may cause the LTM transformer to generate a preference score (e.g., an integer value, a decimal value, a percentage, and/or other scores) indicating a user preference for content items associated with particular attributes. For example, the LTM transformer may process the long-term content viewing information and determine that a particular user viewed forty content items over six months, ten of which were video games. Based on the determination, the LTM transformer may generate a preference score indicating, for example, a 25% preference for video games. The RELP 130 may cause the LTM transformer to generate an initial CR data structure comprising user content preference information indicating a user preference corresponding to the one or more preference scores. For example, based on a preference score indicating a 25% preference for video games, the RELP 130 may cause the LTM transformer to generate the initial CR data structure such that the initial CR data structure comprises user content preference information indicating a particular user (or group of users) prefers that one out of every four content times viewed is a video game.

Also or alternatively, the RELP 130 may cause the LTM transformer to compare the one or more preference scores to a threshold, as part of generating the initial CR data structure. Based on comparing the preference scores to the threshold, the RELP 130 may cause the LTM transformer to determine whether one or more preference scores satisfies the threshold score. For example, the LTM transformer may compare a preference score indicating a 25% preference for video games and a preference score indicating a 50% preference for action movies to a threshold that is satisfied by preference scores exceeding 30%. Based on the comparison, the LTM transformer may determine that the preference score indicating a 50% preference for action movies satisfies the threshold but the preference score indicating a 25% preference for video games does not satisfy the threshold. The RELP 130 may cause the LTM transformer to generate the initial CR data structure such that the initial CR data structure comprises user content preference information indicating a particular user prefers one out of every two content items viewed to be an action movie. The methods by which the RELP 130 may cause the LTM transformer to generate the initial CR data structure may comprise additional and/or alternative parameters and/or steps without departing from the scope of this disclosure.

At step 413, and further as part of generating the initial content recommendations (e.g., as part of the first/training iteration of a feedback loop), the RELP 130 may receive recent content viewing information from the RHDB 141. For example, the RELP 130 may receive the recent content viewing information via the communication interface 133. The recent content viewing information may be received as a stream of data, a data file, and/or any other means of providing data from one computing device to another computing device. The recent content viewing information may comprise content viewing information corresponding to a particular term subsequent to the term associated with the long-term content viewing information of step 410. For example, if the long-term content viewing information of step 410 corresponds to the six months from July through December of the previous calendar year, the recent content viewing information may correspond to a subsequent term, such as the most recent six months (e.g., January through June of the current calendar year) up to and including the date the recent content viewing information is received by the RELP 130.

At step 414, the RELP 130 may (e.g., based on receiving the recent content viewing information) train a CR transformer, and/or other machine learning models. Training the CR transformer may configure the CR transformer to output content recommendations based on input of CR data structures and content viewing information (e.g., updated content viewing information, such as the recent content viewing information of step 413). For example, the RELP 130 may train the CR transformer based on the recent content viewing information of step 413 and the initial CR data structure of step 412. In training the CR transformer, the RELP 130 may process the recent content viewing information and/or the initial CR data structure using one or more processors by applying natural language processing and/or understanding, supervised machine learning methods (e.g., regression, classification, neural networks, support vector machines, random forest models, naïve Bayesian models, and/or other supervised methods), unsupervised machine learning methods (e.g., principal component analysis, hierarchical clustering, K-means clustering, and/or other unsupervised methods), and/or other methods.

In training the CR transformer, the RELP 130 may train the CR transformer to identify correlations between the recent content viewing information and the CR data structure. For example, the RELP 130 may train the CR transformer to identify correlations between one or more attributes in the recent content viewing information and user content preference information of the CR data structure. The correlations may comprise indications of matches between the attributes in the recent content viewing information and the user content preference information.

The RELP 130 may train the CR transformer to determine a set of content attributes (e.g., based on the correlations between the recent content viewing information and the CR data structure) for use in recommending content. For example, the RELP 130 may train the CR transformer to select one or more content items to recommend based on determining that the one or more content items correspond to the set of content attributes, as described further below. The RELP 130 may train the CR transformer to generate content recommendations based on content items stored in one or more content repositories, such as a server at local office 103 (e.g., servers 105, 106, 107, and/or other servers), a remote cloud server storing content items, a secondary content platform (e.g., SCP 150, and/or other secondary content platforms), and/or other content repositories. For example, the RELP 130 may train the CR transformer to select content items to recommend from the one or more content repositories based on the set of content attributes identified by the CR transformer.

At step 415, and further as part of generating the initial content recommendations (e.g., as part of the first/training iteration of a feedback loop), the RELP 130 may receive additional recent content viewing information from the RHDB 141. For example, the RELP 130 may receive the additional recent content viewing information based on a period of time that has passed between receiving the recent content viewing information of step 413 and training the CR transformer. For example, the RELP 130 may have received the recent content viewing information of step 413 on, for example, Tuesday, and may receive the additional content viewing information of step 415 on Thursday of the same week based on completing training of the CR transformer. The RELP 130 may receive the additional recent content viewing information via the communication interface 133. The recent content viewing information may be received as a stream of data, a data file, and/or any other means of providing data from one computing device to another computing device.

At step 416, the RELP 130 may (e.g., based on receiving the recent content viewing information of step 413 and/or the additional recent content viewing information of step 415) generate the initial content recommendations. The RELP 130 may generate the initial content recommendations by inputting the initial CR data structure and recent content viewing information (e.g., the recent content viewing information of step 413 and/or the additional recent content viewing information of step 415) into the CR transformer. The RELP 130 may cause the CR transformer to generate the initial content recommendations based on identifying correlations between one or more attributes in the recent content viewing information and user content preference information of the initial CR data structure. For example, the CR transformer may identify a correlation between 1) attributes of content items viewed by a particular user within a period of time (e.g., six months) corresponding to a second term, subsequent to the first term corresponding to the long-term content viewing information, for providing content recommendations, such as a genre (e.g., sports), and 2) user content preference information of the initial CR data structure indicating a preference, for example, for audio content.

As part of generating the initial content recommendations, the RELP 130 may cause the CR transformer to determine a set of content attributes (e.g., based on the correlations between the recent content viewing information and the initial CR data structure). The set of content attributes may comprise a plurality of attributes that may be associated with content items, such as titles of content items, individuals (e.g., actors, directors, or the like) associated with content items, genres (e.g., action, drama, science fiction, mystery, comedy, sports, and/or other genres) of content items, types of content items (e.g., a movie, a series of episodes, advertising content, video game content, audio content (e.g., music, podcasts, and/or other audio content), and/or other types of content), a particular time (e.g., time of day, time of month, time of year, a holiday, and/or other times) content items are available for viewing, and/or other attributes of content items. For example, based on identifying a correlation between attributes of content items viewed by a particular user, such as a sports genre, and user content preference information of the initial CR data structure indicating a preference, for example, for audio content, the CR transformer may generate a set of content attributes comprising a type of content item (e.g., podcasts) and a genre of content item (e.g., sports).

The RELP 130 may cause the CR transformer to generate the initial content recommendations by selecting, as the initial content recommendations, one or more content items corresponding to the set of content attributes. For example, based on a set of content attributes comprising a type of content item (e.g., podcasts) and a genre of content item (e.g., sports), the CR transformer may select, as the initial content recommendations, one or more sports podcasts. The RELP 130 may cause the CR transformer to select the one or more content items from one or more content repositories.

At step 417, and based on generating the initial content recommendations, the RELP 130 may output the initial content recommendations. To output the initial content recommendations, the RELP 130 may send the initial content recommendations to the GW 402. For example, the RELP 130 may send the initial content recommendations by communicating with the GW 402 via a communication interface (e.g., the communication interface 133). Also or alternatively, the RELP 130 may send the initial content recommendations to the GW 402 via one or more intermediary devices and/or connections, such as external network 109, local office 103, interface 120, modem 110, and/or other devices or connections. Based on sending the initial content recommendations, the RELP 130 may complete a first/training iteration of a feedback loop (e.g., an iterative feedback loop for providing content recommendations using recursive learning, as described herein). It should be understood that the RELP 130 may send the initial content recommendations to one or more additional gateways corresponding to different users without departing from the scope of this disclosure. Additionally or alternatively, the RELP 130 may send the initial content recommendations to one or more additional gateways and/or user devices associated with a particular user. For example, the RELP 130 may send the initial content recommendations to gateways at different geographic locations associated with the same user (e.g., a permanent residence and a temporary residence, and/or other geographic locations). As an additional or alternative example, the RELP 130 may send the initial content recommendations to a plurality of user devices (e.g., a smartphone, a laptop, a tablet, and/or other user devices) associated with the same user.

At step 418, the RHDB 141 may receive content viewing information from the GW 402. Step 418 may comprise the beginning step of an iterative feedback loop for providing content recommendations using recursive learning, as described herein (e.g., an iterative feedback loop performed repeatedly after completing an initial/training iteration as described above at steps 410-417). The content viewing information received by the RHDB 141 may comprise information, such as indications of content that was viewed, a length of time during which content was viewed, a time at which content was viewed, an indication of the device communicating the content viewing information, attributes of content that was viewed, and/or other information associated with one or more content items, that corresponds to a particular term (e.g., a number of days, a number of weeks, a number of months, a number of years, and/or any other periods of time). The content viewing information may correspond to the initial content recommendations and/or other content recommendations. The content viewing information may correspond to one or more users associated with services provided by the RELP 130. Although only one GW 402 is depicted, the RHDB 141 may receive the content viewing information from one or more additional computing devices or systems of devices, such as gateways, interfaces, local offices, and/or other computing devices or systems of devices corresponding to different users, without departing from the scope of this disclosure.

At step 419, based on receiving the content viewing information of step 418, the RHDB 141 may update the recent content viewing information stored by the RHDB 141. For example, the RHDB 141 may update the recent content viewing information to incorporate the content viewing information of step 418. To update the recent content viewing information, the RHDB 141 may store the content viewing information of step 418 and designate any content viewing information stored at the RHDB 141 longer than the particular term (e.g., six months) as long-term content viewing information. For example, if the RHDB 141 receives content viewing information daily, the RHDB 141 may update the recent content viewing information daily by storing the content viewing information of step 418 and designate all content viewing information that has been stored by the RHDB 141 for a period longer than, for example, six months from the current day as long-term content viewing information.

At step 420 (FIG. 4B), the RHDB 141 may send long-term content viewing information to LTHDB 142. The long-term content viewing information may comprise the current/most up-to-date long-term content viewing information, formerly designated as recent content viewing information, stored at the RHDB 141 for a period of time longer than a particular term (e.g., a number of days, a number of weeks, a number of months, a number of years, and/or any other periods of time, for example, six months). For example, the long-term content viewing information may comprise the recent content viewing information designated as long-term content viewing information at step 419.

At step 421, based on receiving the long-term content viewing information of step 420, the LTHDB 142 may update the long-term content viewing information stored by the LTHDB 142. For example, the LTHDB 142 may update the long-term content viewing information to incorporate the long-term content viewing information of step 420. To update the long-term content viewing information, the LTHDB 142 may store the long-term content viewing information of step 420 and delete, transfer, and/or otherwise remove any content viewing information stored at the LTHDB 142 for a period of time longer than a particular term (e.g., six months). For example, if the RHDB 141 stores content viewing information from the most recent six months (e.g., January through June of the current year), the LTHDB may remove any content viewing information stored at the LTHDB 142 for a period of time longer than the preceding six months (e.g., July through December of the previous year).

At step 422, based on updating the long-term content viewing information, the LTHDB 142 may send long-term content viewing information to the RELP 130. The long-term content viewing information may comprise the updated/current long-term content viewing information of step 421. The LTHDB 142 may perform step 422 continuously or periodically (e.g., as new long-term content viewing information is received and the LTHDB 142 is updated).

At step 423, based on receiving the long-term content viewing information of step 422, the RELP 130 may modify, convert, compress, and/or otherwise update an LTM data structure based on a CR data structure. The LTM data structure may be and/or comprise one or more CR data structures previously generated and modified, converted, compressed and/or otherwise updated by the RELP 130 (e.g., as part of one or more previous iterations of an iterative feedback loop for providing content recommendations as described herein). The CR data structure may comprise the initial CR data structure, a CR data structure previously generated by the RELP 130 (e.g., as part of one or more previous iterations of an iterative feedback loop for providing content recommendations as described herein), and/or other CR data structures. The LTM data structure may summarize content preference information over a period of time (e.g., days, months, weeks, years, etc.) representing the entire period of time/term a user corresponding to the content preference information has been associated with the RELP 130 (e.g., receiving content recommendation services from RELP 130, receiving services from the entity associated with RELP 130, and/or otherwise associated with the RELP 130). To update the LTM data structure, the RELP 130 may compare the CR data structure to an existing LTM data structure to identify updates for that LTM data structure. Based on comparing the CR data structure to the LTM data structure, the RELP 130 may modify and/or otherwise update the existing LTM data structure to incorporate and/or match user content preference information of the CR data structure into the LTM data structure. For example, based on CR data structure comprising an indicator of a preference for comedy content items over drama content items, the RELP 130 may modify an LTM data structure comprising an indicator of a preference for action content items over drama content items to further comprise an indicator that comedy content items are preferred over drama content items. Alternatively, if there is no existing LTM data structure (e.g., if RELP 130 is performing a first iteration of the iterative feedback loop), the RELP 130 may update properties of the CR data structure and/or otherwise designate the CR data structure as an LTM data structure.

Also or alternatively, to update the LTM data structure the RELP 130 may compress the LTM data structure to maintain a file storage size, memory usage, and/or other indicator of an amount of resources necessary to maintain the LTM data structure. For example, if an existing LTM data structure initially comprises a size of 10 megabytes (MB), the RELP 130 may compress the existing LTM data structure, updated based on the CR data structure, to maintain the size of 10 MB. To compress the LTM data structure, the RELP 130 may combine, restructure, and/or otherwise modify user content preference information of the LTM data structure to reduce its size. For example, the RELP 130 may condense an indicator of a preference for action content items over drama content items and an indicator of a preference for comedy content items over drama content items into a single indicator of a preference for action content items, over comedy content items, which are in turn preferred over drama content items (e.g., based on preference scores associated with the preferences for comedy, drama, and action content items). Also or alternatively, the RELP 130 may compress a plurality of indicators of user preferences for particular content items into a single indicator of a preference for one or more attributes of the particular content items. For example, the RELP 130 may compress one or more indicators of a preference for sports movies and one or more indicators of a preference for content items associated with a particular actor into an indicator of a preference for sports movies associated with the particular actor.

The RELP 130 may combine, restructure, and/or otherwise modify user content preference information of the LTM data structure to reduce its size based on one or more thresholds. For example, the RELP 130 may compress, combine, and/or otherwise modify a plurality of indicators of user preferences into a single indicator of user preferences based on determining whether the plurality of indicators satisfies a threshold number of indicators. In an example, the LTM data structure may comprise a plurality of indicators of a user requesting audio content (e.g., podcasts, and/or other audio content) at a particular time of day (e.g., 5 PM, and/or other times) and a threshold number of indicators may be ten indicators. Based on comparing the plurality of indicators to the threshold number of indicators the RELP 130 may determine that the plurality of indicators indicate the user requested audio content eleven times at the particular time of day and that the threshold number of indicators is satisfied. Accordingly, the RELP 130 may compress the plurality of indicators into a single indicator of a user preference for receiving audio content at the particular time of day. By repeating the functions of step 423 (e.g., as part of future iterations of the iterative feedback loop as described herein) the RELP 130 may cause the LTM data structure to maintain a summary of user content preferences over any period of time including, for example, the entire period of time a user is associated with the RELP 130.

At step 424, based on updating the LTM data structure, the RELP 130 may retrain, refine, and/or otherwise update the LTM transformer. To update the LTM transformer, the RELP 130 may input the LTM data structure into the LTM transformer as an additional training set. By providing the LTM data structure as an input into the LTM transformer, the RELP 130 may create or continue an iterative feedback loop that may continuously and dynamically update the LTM transformer. The iterative feedback loop may improve the LTM transformer's accuracy and/or efficiency. For example, based on inputting the LTM data structure into the LTM transformer, the RELP 130 may cause the LTM transformer to update the correlations between attributes of content items and user content preferences stored during training of the LTM transformer. The LTM transformer may update the correlations based on user content preference information of the LTM data structure. The LTM transformer may generate CR data structures in future iterations of the iterative feedback loop based on the updated correlations.

At step 425, the RELP 130 may (e.g., as part of an iterative feedback loop for providing content recommendations, as described herein) generate a CR data structure. The CR data structure may summarize user content preference information over a first term for providing content recommendations (e.g., the period of time corresponding to the long-term content viewing information of step 422. The RELP 130 may generate the CR data structure by inputting the current/most up-to-date long-term content viewing information of step 422 and the LTM data structure of step 423 into the LTM transformer. For example, the RELP 130 may generate the CR data structure, based on the long-term content viewing information and the LTM data structure, summarizing user content preferences over the first term (e.g., the period of time corresponding to the term of the long-term content viewing information of step 422). The CR data structure may also summarize the user content preference information of the LTM data structure of step 423. For example, the CR data structure may comprise the summary of user content preferences over the entire period of time a user is associated with the RELP 130 and a summary of user content preferences over the first term (e.g., the period of time corresponding to the term of the long-term content viewing information).

To generate the CR data structure, the RELP 130 may cause the LTM transformer to parse, mine, and/or otherwise process the long-term content viewing information to extract user content preference information for one or more content items. The user content preference information may represent content preferences over the first term (e.g., the period of time corresponding to the long-term content viewing information, for example, July through December of the previous year). The RELP 130 may cause the LTM transformer to identify, match, and/or otherwise determine correlations between the user content preference information (and/or the corresponding content items) and portions of the LTM data structure. For example, the LTM transformer may identify, based on processing the long-term content viewing information, that a user has played forty video games in the period of time associated with the long-term content viewing information. The LTM transformer may also identify, based on the LTM data structure, that the user prefers, e.g., action content items. Based on these identifications the LTM transformer may determine a correlation between video games and action content items and generate, based on the correlation, a CR data structure comprising user content preference information indicating a preference for video games from the action genre.

To generate the CR data structure, the RELP 130 may additionally or alternatively cause the LTM transformer to perform the same or similar functions as the LTM transformer used to generate the initial CR data structure of step 412. For example, the RELP 130 may cause the LTM transformer to generate preference scores indicating a user preference for content items associated with particular attributes. The RELP 130 may cause the LTM transformer to generate a CR data structure comprising user content preference information indicating user preferences corresponding to the preference scores. Also or alternatively, the RELP 130 may cause the LTM transformer to compare the preference scores to a threshold. Based on comparing the preference scores to the threshold, the RELP 130 may cause the LTM transformer to determine whether one or more preference scores satisfies the threshold score. The RELP 130 may cause the LTM transformer to generate a CR data structure comprising user content preference information indicating user preferences corresponding to the preference scores that satisfied the threshold. The methods by which the RELP 130 may cause the LTM transformer to generate the CR data structure may comprise additional and/or alternative parameters and/or steps without departing from the scope of this disclosure

At step 426, the RELP 130 may receive recent content viewing information from the RHDB 141. For example, the RELP 130 may receive the recent content viewing information via the communication interface 133. The recent content viewing information may be received as a stream of data, a data file, and/or any other means of providing data from one computing device to another computing device. The recent content viewing information may comprise content viewing information corresponding to a particular term (e.g., a second term) subsequent to the first term corresponding to the long-term content viewing information of step 422.

At step 427, the RELP 130 may (e.g., as part of an iterative feedback loop for providing content recommendations, as described herein) generate content recommendations. The RELP 130 may generate the content recommendations by inputting the CR data structure of step 425 and the recent content viewing information of step 426 into the CR transformer. Based on inputting the CR data structure and the recent content viewing information, the RELP 130 may cause the CR transformer to generate the content recommendations by performing the same or similar functions as the CR transformer used to generate the initial content recommendations of step 416. For example, the RELP 130 may cause the CR transformer to generate the content recommendations based on identifying correlations between attributes in the recent content viewing information and the user content preference information of the CR data structure. Because the CR data structure of step 425 was generated based in part on the LTM data structure, the CR data structure may represent an update to the LTM data structure. For example, the CR data structure may comprise user content preference information indicating user content preferences over any period of time (e.g., the entire period of time a user has been associated with the RELP 130) that may be used to identify the correlations. For example, the CR transformer may identify a correlation between recent content viewing information indicating a user viewed a number of content items sharing the comedy genre attribute and user content preference information indicating a preference for viewing a content item with the comedy genre attribute and the movie content type attribute on the same day, every year, over a number of years.

As part of generating the content recommendations, the RELP 130 may cause the CR transformer to determine a set of content attributes (e.g., based on the correlations determined by the CR transformer). The set of content attributes may comprise a plurality of attributes that may be associated with content items, such as titles of content items, individuals (e.g., actors, directors, or the like) associated with content items, genres (e.g., action, drama, science fiction, mystery, comedy, sports, and/or other genres) of content items, types of content items (e.g., movie, series of episodes, advertising content, video game content, audio content (e.g., music, podcasts, and/or other audio content), and/or other types of content), a particular time (e.g., time of day, time of month, time of year, a holiday, and/or other times) content items are available for viewing, and/or other attributes of content items. For example, based on identifying a correlation between recent content viewing information indicating a user viewed a number of content items sharing the comedy genre attribute and user content preference information indicating a preference for viewing a content item with the comedy genre attribute and the movie content type attribute on the same day (e.g., June 1st) every year, the CR transformer may generate a set of content attributes comprising a genre of content item (e.g., comedy), a type of content item (movie), and a time to view the content item (e.g., June 1st).

The RELP 130 may cause the CR transformer to generate the content recommendations by selecting one or more content items corresponding to the set of content attributes of step 427. For example, based on a set of content attributes comprising a genre of content item (e.g., comedy), a type of content item (movie), and a time to view the content item (e.g., June 1st), the CR transformer may select, as the content recommendations, one or more comedy movies available for viewing on June 1st. The RELP 130 may cause the CR transformer to select the content items for the content recommendations from one or more content repositories. The content recommendations may comprise recommendations for movies, series of episodes, advertisements, video games, audio content (e.g., podcasts, music, audiobooks), and/or any other type of content item.

The RELP 130 may (e.g., based on rules, instructions, parameters, etc. encoded into the RELP 130 and/or provided to the RELP 130 during training of the CR) modify the content recommendations based on contextual information. The contextual information may comprise and/or be comprised of the recent content viewing information of step 426. The contextual information may be associated with a destination of the content recommendations, associated with delivery of the content recommendations, and/or otherwise associated with the content recommendations. For example, the contextual information may comprise a time of day (e.g., morning, afternoon, evening, and/or other times of day), a particular event (e.g., Olympic Games, a sports championship, a holiday, and/or other public events), a user profile (e.g., a profile of a particular member of a household, a parental-locked profile, and/or other user profiles), a geographic location (e.g., state, country, zip code, address, and/or other locations) associated with the recommended content items, a geographic location associated with a destination of the content recommendations, and/or other contextual information.

The RELP 130 may cause the CR transformer to modify the content recommendations based on the contextual information. For example, based on inputting, as contextual information, an indication that a sports championship is occurring on the day the content recommendations are generated, the RELP 130 may cause the CR transformer to modify (e.g., based on the user content preference information of the CR data structure) the content recommendations to add a recommendation for a service streaming the sports championship. As an additional or alternative example, the RELP 130 may determine that a device (e.g., GW 402) to which the content recommendations are to be sent is in a geographic location with a different time zone than the geographic location to which content recommendations were previously sent (e.g., in previous iterations of an iterative feedback loop for providing content recommendations, as described herein). In such an example, the RELP 130 may cause the CR transformer to modify the content recommendations to include recommendations for content items available in the appropriate time zone.

At step 428, based on generating the content recommendations, the RELP 130 may output the content recommendations. For example, the RELP 130 may output the content recommendations by sending the content recommendations to a user via GW 402, and/or other gateways. The RELP 130 may send the content recommendations by communicating with the GW 402 via a communication interface (e.g., the communication interface 133). Also or alternatively, the RELP 130 may send the content recommendations to the GW 402 via one or more intermediary devices and/or connections, such as external network 109, local office 103, interface 120, modem 110, and/or other devices or connections. The RELP 130 may send the content recommendations to one or more additional gateways corresponding to different users without departing from the scope of this disclosure. Additionally or alternatively, the RELP 130 may send the content recommendations to one or more additional gateways and/or user devices associated with a particular user. For example, the RELP 130 may send the content recommendations to gateways at different geographic locations associated with the same user (e.g., a permanent residence and a temporary residence, and/or other geographic locations). As an additional or alternative example, the RELP 130 may send the content recommendations to a plurality of user devices (e.g., a smartphone, a laptop, a tablet, and/or other user devices) associated with the same user.

To output the content recommendations to the GW 402, the RELP 130 may generate a content lineup comprising the content recommendations or insert the content recommendations into a content lineup. An example content lineup may comprise a playlist configured to automatically initiate playback of content items, a stream of data configured to cause an interface to show a list and/or other lineup of content items, and/or any other means of presenting content recommendations to a user (e.g., via a computing device such as display device 112, personal computer 114, laptop computer 115, mobile device 125, wireless device 116, and/or other devices 113). For example, the RELP 130 may output the content recommendations by inserting the content recommendations into a stream of data that causes output of a user interface at a user device in communication with the GW 402, such a user interface 501 as depicted in FIG. 5.

FIG. 5 shows an example of a user interface 501 that may be output in connection with step 428. The user interface 501 may be output by any device in communication with GW 402 and capable of outputting a user interface, such as a display device 112, a personal computer 114, a laptop computer 115, a mobile device 125, a wireless device 116, and/or any other devices 113. The user interface 501 may comprise text 502 related to presenting content recommendations to a user, such as an identification of the user, an indication that the content items presented are recommended content items, and/or any other information related to presenting content recommendations. The user interface 501 may further comprise one or more selectable options 503, 504, and 505 indicating content items, based on the content recommendations, that may be selected by the user for playback. The options (503, 504, 505, and/or other options) may be selectable by touching a display region corresponding to the option, selecting the option using a device (e.g., a remote control, a computer mouse, and/or other devices), executing a voice command directing the device outputting user interface 501 to select the option, and/or other means of selection.

The output of the user interface 501 may be caused by the sending of the content recommendations in step 428, and/or by the sending of one or more other communications. For example, step 428 may comprise sending, to the GW 402, the content recommendations and one or more commands directing the GW 402 to cause output of the user interface 501. Although not shown in FIG. 4B, the GW 402 may, based on the one or more commands, send a separate message (e.g., to a device capable of outputting a user interface) that causes output of the user interface 501.

Additionally or alternatively, the RELP 130 may cause output of the content recommendations by sending the content recommendations to a computing device that is not owned or maintained by the entity associated with RELP 130. For example, the RELP 130 may send the content recommendations to SCP 150. The RELP 130 may cause, based on sending the content recommendations to the SCP 150, the SCP 150 to send a content lineup to the GW 402. For example, the SCP 150 may send a content lineup comprising content recommendations for content owned and/or streamed exclusively by the SCP 150. The sending of the content lineup to the GW 402 may cause output of a user interface similar to user interface 501.

At step 429, the RELP 130 may (e.g., based on one or more instructions stored by the RELP 130) generate a record of user content preferences. For example, the RELP 130 may generate a digital file, a report, a summary, and/or other records of user content preferences based on the content recommendations of step 427. The record of user content preferences may comprise a list of attributes of recommended content items (e.g., content type, content length, genre, and/or other attributes), a list of content items included in the content recommendations of step 427, a list of historical content recommendations (e.g., content items recommended in one or more previous iterations of an iterative feedback loop as described herein), indicators of user content preference information used to generate the content recommendations, content viewing information used to generate the content recommendations, and/or other information. The record of user content preferences may comprise a summary of any information used to train machine learning models, generate CR data structures and/or generate content recommendations as part of an iterative feedback loop for providing content recommendations, as described herein.

At step 430, the RELP 130 may send the record of user content preferences to the SCP 150 and/or to other computing devices owned and/or maintained by an entity different from the entity associated with RELP 130. To send the record of user content preferences, the RELP 130 may determine one or more content providers (e.g., SCP 150, and/or other content providers) associated with the user content preference report. For example, the RELP 130 may send the record of user content preferences based on a contract and/or other agreement to provide records of user content preferences (e.g., in exchange for incentives, such as shares of revenue, credits, and/or other incentives) to providers of particular content items (e.g., streaming services, and/or other content providers). The record of user content preferences may be used by one or more devices (e.g., SCP 150) to generate other content recommendations, track user engagement with recommended content, and/or for other purposes. At step 431 (FIG. 4C), the RELP 130 may receive an incentive, such as a share of revenue, a credit, and/or other incentives, from the SCP 150. For example, the RELP 130 may receive a content recommendation incentive (e.g., as a form of payment) for providing content recommendations and/or for sending a record of user content preferences. The incentive may be based on the content recommendations of step 427 comprising one or more content items associated with the SCP 150. Additionally or alternatively, the incentive may be based on the SCP 150 requesting and/or using information of the record of user content preferences of step 430. Although not shown in FIG. 4C, the RELP 130 may receive one or more additional incentives from one or more additional computing devices (e.g., based on providing the additional computing devices with the record of user content preferences).

At step 432, the GW 402 may send a content request to the server 401. For example, the GW 402 may send a content request for one or more content items included in the content recommendations sent to the GW 402 at step 428. The content request may be sent in response to user input at a user interface (e.g., user interface 501) selecting the one or more content items for playback. The content request may comprise a message indicating a user has provided the user input selecting the one or more content items for playback. Also or alternatively, the content request may be sent automatically based on one or more tags, indicators, and/or other triggers included in content items. For example, based on a trigger in a content item, such as a series of episodes, indicating a location for placement of an advertisement, a content request comprising a request for advertising content may be sent to the server 401. The content request may comprise a request for content items such as movies, series of episodes, advertisements, video games, audio content, and/or any other type of content item. At step 433, based on receiving the content request of step 432, the server 401 may send requested content to the GW 402.

At step 434, the GW 402 may send recommended content viewing information to the SCP 150. The recommended content viewing information may comprise content viewing information associated with the content recommendations sent by the RELP 130 at step 428. For example, the recommended content viewing information may comprise information indicating user engagement with the content recommendations, such as indications that a user viewed recommended content items, indications of how long the user viewed recommended content items, indications that a user selected recommended content items (e.g., via a computer mouse, touchscreen, remote control, etc.), a time (e.g., hour, day, week, month, year, etc.) a user interacted with recommended content items, and/or other information. The GW 402 may send the recommended content viewing information to the SCP 150 as part of a contract and/or other agreement between the entity associated with SCP 150 and the entity associated with RELP 130. Based on receiving the recommended content viewing information at step 434, the SCP 150 may send incentives (e.g., incentives described in step 431) to the RELP 130. At step 435, the GW 402 may send the recommended content viewing information to the RELP 130. The GW 402 may send the recommended content viewing information to the RELP 130 in addition to, or as an alternative to, sending the recommended content viewing information to the SCP 150 at step 434.

At step 436, the RELP 130 may, based on receiving the recommended content viewing information, generate an impression report. The impression report may comprise impressions, such as information indicating whether a user viewed, activated, interacted with, and/or otherwise engaged with recommended content items based on the content recommendations sent at step 428. To generate the impression report, the RELP 130 may determine, based on parsing, analyzing, and/or otherwise processing the recommended content viewing information, impressions for one or more content items. For example, based on the recommended content viewing information, the RELP 130 may determine, based on the recommended content viewing information, that a user viewed a first advertisement, selected (e.g., via a touchscreen) a second advertisement, and skipped a third advertisement. The RELP 130 may, as part of determining the impressions, assign values, scores, labels, etc., to the impressions. For example, based on determining that a user viewed a first advertisement, selected a second advertisement, and skipped a third advertisement, the RELP 130 may assign, for example, a label marking the view of the first advertisement as a partial impression, a label marking the selection of the second advertisement as a full impression, and a label marking that the skipping of the third advertisement is not an impression. The RELP 130 may generate an impression report comprising the impressions determined by the RELP 130. At step 437, the RELP 130 may send the impression report to the SCP 150, and/or to computing devices associated with additional content providers (e.g., advertisers, streaming services, and/or other content providers).

At step 438, based on sending the impression report at step 437, the RELP 130 may receive an incentive, such as a share of revenue, a credit, and/or other incentives, from the SCP 150 (and/or other computing devices associated with additional content providers). For example, the RELP 130 may receive an impression incentive (e.g., as a form of payment) for providing content recommendations for content items associated with an impression, and/or for sending an impression report. The incentive may be based on a number of impressions included in the impression report and/or values, scores, labels, etc. assigned to the impressions. For example, the incentive received for a full impression may exceed the incentive received for a partial impression.

At step 439, the RELP 130 may retrain, refine, and/or otherwise update the CR transformer. To update the CR transformer, the RELP 130 may input recommended content viewing information (e.g., as an additional training set of updated content viewing information). For example, the RELP 130 may input the recommended content viewing information received, based on outputting the content recommendations at step 428, by the RELP 130 at step 435. By providing the recommended content viewing information as an input into the CR transformer, the RELP 130 may create or continue an iterative feedback loop that may continuously and dynamically update the CR transformer. The iterative feedback loop may improve the CR transformer's accuracy and/or efficiency. For example, based on inputting the recommended content viewing information into the CR transformer, the RELP 130 may cause the CR transformer to update processes for determining sets of content attributes for use in recommending content. For example, based on recommended content viewing information comprising an indication that a user did not view any recommended content items associated with a particular attribute (e.g., the horror genre, and/or any other attributes of content items), the CR transformer may add a rule, store a correlation, and/or otherwise update a process for determining sets of content attributes such that content items associated with the particular attribute will not be included in sets of content attributes determined by the CR transformer in future iterations of the feedback loop. As another example, the RELP 130 may determine, based on recommended content viewing information, that a user viewed every recommended content item, included in the content recommendations outputted at step 428, associated with a particular attribute. Based on such a determination, the CR transformer may update a process for determining sets of content attributes such that the CR transformer will include the particular attribute in sets of content attributes determined by the CR transformer in future iterations of the feedback loop.

At step 440, based on performing some or all of steps 418-439, the RELP 130 may determine that an iteration of an iterative feedback loop for providing content recommendations has been completed. The RELP 130 may repeat an iterative feedback loop by returning to step 418 and beginning a new iteration of the iterative feedback loop. For example, based on outputting the content recommendations at step 428, updating the LTM transformer at step 424, updating the CR transformer at step 439, and/or based on performing other functions described herein, the RELP 130 may use the LTM transformer and the CR transformer to generate additional content recommendations (e.g., based on updated content viewing information) in continuous or periodic future iterations of the iterative feedback loop described herein.

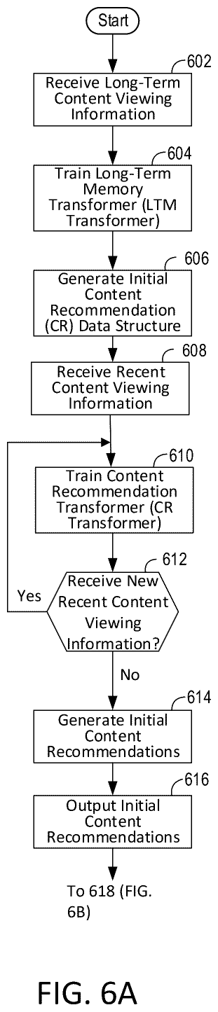

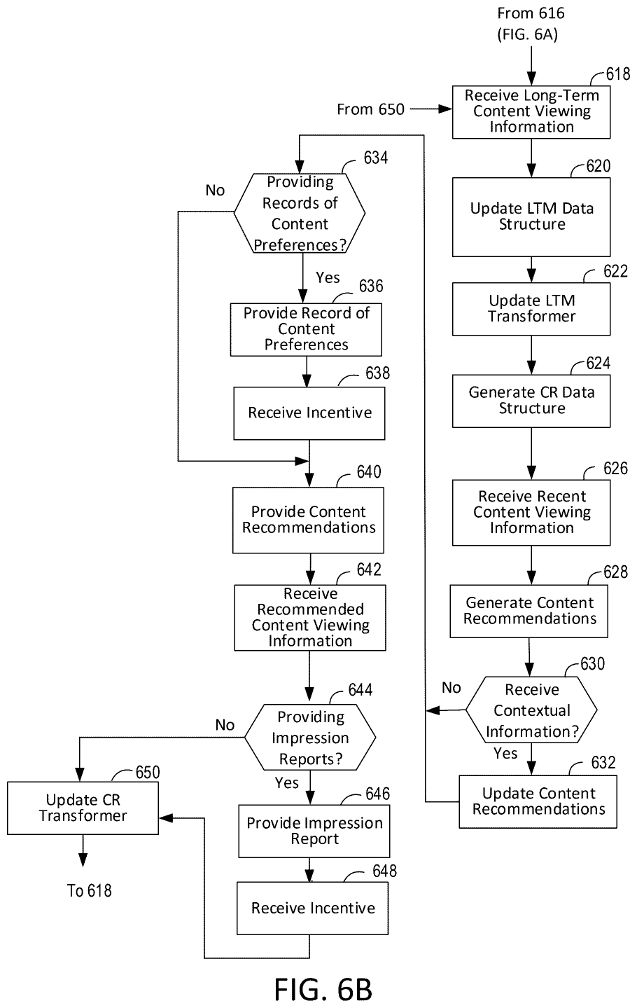

FIGS. 6A and 6B are a flow chart showing steps of an example method associated with providing content recommendations using recursive learning. One, some, or all steps of the example method of FIGS. 6A and 6B may be performed by a recursive embedding learning platform (RELP) (e.g., the RELP 130) as part of one or more of the steps described in connection with FIGS. 4A-4C. Additionally or alternatively, one, some, or all steps of the example method of FIGS. 6A and 6B may be performed by one or more other computing devices. Steps of the example method of FIGS. 6A and 6B may be omitted, performed in other orders, and/or otherwise modified, and/or one or more additional steps may be added.

At step 602, the RELP may receive long-term content viewing information (e.g., from a database, such as LTHDB 142, and/or other databases). The long-term content viewing information may correspond to a term. Step 602 may be similar to and/or may comprise (and/or be comprised by) step 410 of FIG. 4A. At step 604, based on receiving the long-term content viewing information, the RELP may train a long-term memory (LTM) transformer. The LTM transformer may comprise a machine learning model configured to generate content recommendation (CR) data structures based on input of LTM data structures and long-term content viewing information. Step 604 may be similar to and/or may comprise (and/or be comprised by) step 411 of FIG. 4A. At step 606, the RELP may generate an initial CR data structure. The RELP may generate the initial CR data structure using the LTM transformer. The initial CR data structure may comprise user content preference information and/or may summarize user content preference information over a period of time. Step 606 may be similar to and/or may comprise (and/or be comprised by) step 412 of FIG. 4A.

At step 608, the RELP may receive recent content viewing information (e.g., from a database, such as RHDB 141, and/or other databases). The recent content viewing information may correspond to a term (e.g., a different term from the long-term content viewing information of step 602). Step 608 may be similar to and/or may comprise (and/or be comprised by) step 413 of FIG. 4A. At step 610, based on receiving the recent content viewing information, the RELP may train a CR transformer. The CR transformer may comprise a machine learning model configured to generate content recommendations based on input of CR data structures and recent content viewing information. Step 610 may be similar to and/or may comprise (and/or be comprised by) step 414 of FIG. 4A.

At step 612, the RELP may determine if it has received new and/or updated recent content viewing information. If not, step 614 may be performed. If new and/or updated recent content viewing information has been received (e.g., if the RELP has received recent content viewing information such as the recent content viewing information of step 415 of FIG. 4A), step 610 may be repeated. At step 614, the RELP may generate initial content recommendations. The RELP may generate the initial content recommendations using the CR transformer. The RELP may generate the initial content recommendations based on recent content viewing information (e.g., the recent content viewing information of steps 608 and/or 612) and based on the initial CR data structure of step 606. The initial content recommendations may comprise content items and/or indicators of content items. Step 614 may be similar to and/or may comprise (and/or be comprised by) step 416 of FIG. 4A. At step 616, the RELP may output the initial content recommendations. The RELP may output the initial content recommendations by sending the initial content recommendations to a gateway (e.g., GW 402, and/or other gateways). Step 616 may be similar to and/or may comprise (and/or be comprised by) step 417 of FIG. 4A.

At step 618 (FIG. 6B), the RELP may receive long-term content viewing information (e.g., from a database, such as LTHDB 142, and/or other databases). The long-term content viewing information may comprise updated content viewing information associated with a term. Step 618 may be similar to and/or may comprise (and/or be comprised by) steps 418-422 of FIG. 4A. At step 620, the RELP may update an LTM data structure. The RELP may update the LTM data structure based on a CR data structure. The CR data structure may comprise the initial CR data structure of step 606 and/or other CR data structures (e.g., CR data structures generated in additional iterations of the method of FIGS. 6A and 6B). Step 620 may be similar to and/or may comprise (and/or be comprised by) step 423 of FIG. 4B. At step 622, the RELP may update the LTM transformer. The RELP may update the LTM transformer based on the long-term content viewing information of step 618 and/or the LTM data structure of step 620. Step 622 may be similar to and/or may comprise (and/or be comprised by) step 424 of FIG. 4B.

At step 624, the RELP may generate a CR data structure. The RELP may generate the CR data structure using the LTM transformer. The CR data structure may comprise user content preference information and/or may summarize user content preference information over a period of time. Step 624 may be similar to and/or may comprise (and/or be comprised by) step 425 of FIG. 4B. At step 626, the RELP may receive recent content viewing information (e.g., from a database, such as RHDB 141, and/or other databases). The recent content viewing information may comprise updated content viewing information associated with a term (e.g., a different term from the long-term content viewing information of step 618). Step 626 may be similar to and/or may comprise (and/or be comprised by) step 426 of FIG. 4B.

At step 628, the RELP may generate content recommendations. The RELP may generate the content recommendations using the CR transformer. The RELP may generate the initial content recommendations based on recent content viewing information (e.g., the recent content viewing information of step 626) and based on the CR data structure of step 624. The content recommendations may comprise content items and/or indicators of content items. Step 628 may be similar to and/or may comprise (and/or be comprised by) some or all of step 427 of FIG. 4B. At step 630, the RELP may determine if it has received contextual information. If not, step 634 may be performed. If contextual information has been received (e.g., the contextual information, and/or instructions to modify content recommendations based on contextual information, of step 427 of FIG. 4B), step 632 may be performed. At step 632, based on determining that contextual information has been received, the RELP may update the content recommendations of step 628 based on the contextual information. Based on updating the content recommendations, step 634 may be performed. Step 632 may be similar to and/or may comprise (and/or be comprised by) some or all of step 427 of FIG. 4B.

At step 634, the RELP may determine whether the RELP is providing records of content preferences. If not, step 640 may be performed. If the RELP is providing records of content preferences (e.g., the record of content preferences of steps 429 and 430 of FIG. 4B), step 636 may be performed. At step 636, based on determining that the RELP is providing records of content preferences, the RELP may provide a record of content preferences. The RELP may provide the record of content preferences by generating a record of content preferences and outputting the record of content preferences. The RELP may provide the record of content preferences to a content platform (e.g., SCP 150, and/or other content platforms). Step 636 may be similar to and/or may comprise (and/or be comprised by) steps 429 and 430 of FIG. 4B. At step 638, based on providing the record of content preferences, the RELP may receive an incentive. The incentive may comprise a share of revenue, credits, and/or other incentives. Based on the RELP receiving the incentive, step 640 may be performed. Step 638 may be similar to and/or may comprise (and/or be comprised by) step 431 of FIG. 4C.

At step 640, the RELP may provide content recommendations (e.g., the content recommendations of steps 628 and/or 632). To provide the content recommendations, the RELP may output the content recommendations to a gateway (e.g., GW 402, and/or other gateways) and/or other computing devices. Step 640 may be similar to and/or may comprise (and/or be comprised by) step 428 of FIG. 4B. At step 642, based on providing the content recommendations, the RELP may receive recommended content viewing information (e.g., from a gateway, such as GW 402, and/or other gateways). The recommended content viewing information may comprise content viewing information associated with the content recommendations of step 640. Step 642 may be similar to and/or may comprise (and/or be comprised by) some or all of steps 432-435 of FIG. 4C.

At step 644, the RELP may determine whether the RELP is providing impression reports. If not, step 650 may be performed. If the RELP is providing impression reports (e.g., the impression reports of steps 436 and 437 of FIG. 4C), step 646 may be performed. At step 646, based on determining that the RELP is providing impression reports, the RELP may provide an impression report. The RELP may provide the impression report by generating an impression report and outputting the impression report. The RELP may provide the impression report to a content platform (e.g., SCP 150, and/or other content platforms). Step 646 may be similar to and/or may comprise (and/or be comprised by) steps 436 and 437 of FIG. 4C. At step 648, based on providing the impression report, the RELP may receive an incentive. The incentive may comprise a share of revenue, credits, and/or other incentives. Based on the RELP receiving the incentive, step 650 may be performed. Step 648 may be similar to and/or may comprise (and/or be comprised by) step 438 of FIG. 4C. At step 650, the RELP may update the CR transformer. The RELP may update the CR transformer based on the recommended content viewing information of step 642. Step 650 may be similar to and/or may comprise (and/or be comprised by) step 439 of FIG. 4C.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a computing device, a first data structure that summarizes user content preference information associated with historical content viewing information of a user;
generating, using a first machine learning model, based on the first data structure and content viewing information corresponding to a first term for providing content recommendations, a second data structure that summarizes user content preference information over the first term for providing content recommendations;
generating, using a second machine learning model and based on the second data structure, one or more content recommendations;
outputting the one or more content recommendations; and
updating, based on the second data structure, the first data structure.

2. The method of claim 1, wherein generating the second data structure comprises:
extracting user content preference information from the historical content viewing information, wherein the extracted user content preference information corresponds to one or more content items recommended to a user within the first term; and
generating, based on determining one or more correlations between the one or more content items and one or more portions of the first data structure, a summary of user content preference information over the first term.

3. The method of claim 1, wherein generating the one or more content recommendations comprises:
determining, based on comparing the second data structure to updated content viewing information that corresponds to a second term for providing content recommendations, one or more correlations between the updated content viewing information and the second data structure;
determining, based on the one or more correlations, a set of content attributes; and
selecting, from one or more content repositories, one or more content items corresponding to the set of content attributes.

4. The method of claim 1, wherein updating the first data structure comprises:
modifying, based on comparing the second data structure to the first data structure, one or more portions of the first data structure to match one or more corresponding portions of the second data structure; and
compressing the first data structure to maintain a memory usage associated with the first data structure.

5. The method of claim 1, further comprising:
modifying, based on contextual information, the one or more content recommendations, wherein the contextual information comprises one or more of:
a time of day associated with the one or more content recommendations,
an event associated with the one or more content recommendations,
a user profile associated with the one or more content recommendations,
a geographic location associated with the one or more content recommendations, or
a geographic location associated with a computing device receiving the one or more content recommendations.

6. The method of claim 1, wherein outputting the one or more content recommendations comprises:
inserting, into a content lineup, the one or more content recommendations.

7. The method of claim 1, wherein outputting the one or more content recommendations comprises:
sending, to an intermediary computing device, the one or more content recommendations,
wherein sending the one or more content recommendations causes the intermediary computing device to provide a content lineup to a second computing device.

8. The method of claim 1, further comprising:
receiving, based on outputting the one or more content recommendations, one or more credits for outputting the one or more content recommendations.

9. The method of claim 1, wherein the one or more content recommendations comprise recommendations for one or more of:
movie content,
episodic content,
advertising content,
video game content, or
audio content.

10. A method comprising:
receiving, by a computing device, a first data structure summarizing user content preference information associated with historical content viewing information of a user;
training, based on the first data structure, a first machine learning model, wherein training the first machine learning model configures the first machine learning model to output data structures summarizing user content preference information of users based on input of content viewing information;
training, based on an initial content recommendation data structure that summarizes user content preference information over a term for providing content recommendations, a second machine learning model, wherein training the second machine learning model configures the second machine learning model to output content recommendations based on input of content recommendation data structures;
outputting one or more content recommendations generated using the first machine learning model and the second machine learning model; and
updating, based on outputting the one or more content recommendations, the first data structure.

11. The method of claim 10, further comprising:
determining, based on outputting the one or more content recommendations, updated content viewing information; and
updating, based on the updated content viewing information and the updated first data structure, the first machine learning model.

12. The method of claim 10, further comprising:
determining, based on outputting the one or more content recommendations, updated content viewing information corresponding to the one or more content recommendations; and
updating, based on the updated content viewing information, the second machine learning model.

13. The method of claim 10, wherein updating the first data structure comprises:
modifying, based on comparing a content recommendation data structure to the first data structure, one or more portions of the first data structure to match one or more corresponding portions of the content recommendation data structure; and
compressing the first data structure to maintain a memory usage associated with the first data structure.

14. The method of claim 10, further comprising:
receiving, based on outputting the one or more content recommendations, one or more credits for outputting the one or more content recommendations.

15. A method comprising:
receiving, at a computing device, a first data structure that summarizes user content preference information associated with historical content viewing information of a user;
generating, based on the first data structure, a second data structure that summarizes user content preference information over a first term for providing content recommendations;
generating, based on the second data structure, one or more content recommendations;
generating, based on the one or more content recommendations, a user content preference report;
outputting the user content preference report; and
updating, based on the second data structure, the first data structure.

16. The method of claim 15, wherein the user content preference report comprises:
the one or more content recommendations,
one or more historical content recommendations, and
content viewing information corresponding to the one or more historical content recommendations.

17. The method of claim 15, wherein outputting the user content preference report comprises:
determining, based on the one or more content recommendations, one or more content providers associated with the user content preference report; and
sending, to the one or more content providers associated with the user content preference report, the user content preference report.

18. The method of claim 15, wherein updating the first data structure comprises:
modifying, based on comparing the second data structure to the first data structure, one or more portions of the first data structure to match one or more corresponding portions of the second data structure; and
compressing the first data structure to maintain a memory usage associated with the first data structure.

19. The method of claim 15, wherein outputting the user content preference report causes inserting, into a content lineup, the one or more content recommendations.

20. The method of claim 15, further comprising:
receiving, based on outputting the user content preference report, one or more credits for outputting the user content preference report.
